(19) United States
(12) Patent Application Publication
(10) Pub. No.: US 2025/0079832 A1
(43) Pub. Date: Mar. 6, 2025

(54) SYSTEM FOR MANAGING DISASTER BASED ON GRID AND OPERATING METHOD OF THE SYSTEM

(71) Applicant: ELECTRONICS AND TELECOMMUNICATIONS RESEARCH INSTITUTE, Daejeon (KR)

(72) Inventors: Sang Gi Hong, Daejeon (KR); Sun-Hwa Lim, Daejeon (KR); Soocheol Kim, Daejeon (KR); Eun Joo Kim, Daejeon (KR); Kyu Won Han, Daejeon (KR)

(21) Appl. No.: 18/662,815

(22) Filed: May 13, 2024

(30) Foreign Application Priority Data
Aug. 28, 2023 (KR) 10-2023-0112723

(51) Int. Cl. H02J 3/00

(52) U.S. Cl. CPC H02J 3/0012; H02J 2203/20

(57) ABSTRACT

A system for managing a disaster based on a grid and an operating method of the system are disclosed. The operating method includes generating one or more models respectively corresponding to one or more sensors, acquiring and storing one or more of one or more pieces of sensing information sensed by the one or more sensors, event information determined based on the one or more pieces of sensing information, and status information of the one or more sensors, in the one or more models, based on multidimensional spatial information based on a grid on which the one or more sensors are disposed, information stored in the one or more models, and disaster information related to the multidimensional spatial information, creating grid-based data to monitor a disaster situation associated with the information stored in the one or more models and/or the multidimensional spatial information, and outputting the created grid-based data.

### CROSS-REFERENCE TO RELATED APPLICATIONS

This application claims the benefit of Korean Patent Application No. 10-2023-0112723, filed on Aug. 28, 2023, in the Korean Intellectual Property Office, the entire disclosure of which is incorporated herein by reference for all purposes.

### BACKGROUND

### 1. Field of the Invention

One or more embodiments relate to a system for managing a disaster based on a grid and an operating method of the system.

### 2. Description of the Related Art

As the structure of cities becomes more complex and overcrowded, it may be necessary to support disaster response-related decision-making, such as providing information about the accurate accident point, disaster scope, or dangerous area, in managing and responding to various disasters. Various sensors may sense values related to a disaster, such as rainfall, temperature, or locations, to respond to the disaster. To specify a space for disaster response and manage information in the space, spatial information based on an address or coordinates may be used.

### SUMMARY

A disaster management platform using spatial information based on an address or coordinates may have a limitation in specifying the accurate accident point. In addition, separate sensor object modeling is required to manage various sensors efficiently and systematically, and a system for registration, management, and analysis in real time may be required.

Various embodiments may provide a sensor object model to register and manage various sensors in a grid-based multidimensional space and a platform for managing the sensor object model.

Various embodiments may create and provide grid-based data to monitor a disaster situation using grid-based spatial information, disaster information, and information sensed by a sensor.

Other objects and advantages of the present disclosure can be understood by the following description and will become more apparent by the embodiments of the present disclosure. In addition, it will be apparent that the objects and advantages of the present disclosure can be readily realized by the means and combinations thereof recited in the claims.

According to an aspect, there is provided an operating method of a system, the method including generating one or more models respectively corresponding to one or more sensors, acquiring and storing one or more of one or more pieces of sensing information sensed by the one or more sensors, event information determined based on the one or more pieces of sensing information, and status information of the one or more sensors, in the one or more models, based on multidimensional spatial information based on a grid on which the one or more sensors are disposed, information stored in the one or more models, and disaster information related to the multidimensional spatial information, creating grid-based data to monitor a disaster situation associated with the information stored in the one or more models and/or the multidimensional spatial information, and outputting the created grid-based data.

The one or more models may include a sensor object model representing a model corresponding to the one or more sensors, a sensor management model including information to manage the one or more sensors, a sensor data model including information received from the one or more sensors, and a sensor data distribution model to query the information received from the one or more sensors.

The sensor object model may include a model for a sensor configured to determine whether an event occurs using the one or more pieces of sensing information sensed by the one or more sensors.

The sensor management model may include information about the one or more sensors and/or information about a dynamic environment setting of the one or more sensors.

The sensor data model may include at least one of the one or more pieces of sensing information sensed by the one or more sensors, the event information, or location information of the one or more sensors.

The grid-based data may control the one or more sensors and/or the one or more models based on the multidimensional spatial information, the information stored in the one or more models, and the disaster information.

The grid-based data may include risk data in a multidimensional space representing a risk according to the disaster situation for each grid.

The outputting of the created grid-based data may include transmitting the created grid-based data to an external system or visualizing the created grid-based data according to a risk.

According to an aspect, there is provided a system including at least one processor configured to generate one or more models respectively corresponding to one or more sensors, acquire and store one or more of one or more pieces of sensing information sensed by the one or more sensors, event information determined based on the one or more pieces of sensing information, and status information of the one or more sensors, in the one or more models, based on multidimensional spatial information based on a grid on which the one or more sensors are disposed, information stored in the one or more models, and disaster information related to the multidimensional spatial information, create grid-based data to monitor a disaster situation associated with the information stored in the one or more models and/or the multidimensional spatial information, and output the created grid-based data.

The one or more models may include at least one of a sensor object model representing a model corresponding to the one or more sensors, a sensor management model including information to manage the one or more sensors, a sensor data model including information received from the one or more sensors, or a sensor data distribution model to query the information received from the one or more sensors.

The sensor object model may include a model for a sensor configured to determine whether an event occurs using the one or more pieces of sensing information sensed by the one or more sensors.

The sensor management model may include information about the one or more sensors and/or information about a dynamic environment setting of the one or more sensors.

The sensor data model may include at least one of the one or more pieces of sensing information sensed by the one or more sensors, the event information, or location information of the one or more sensors.

The grid-based data may control the one or more sensors and/or the one or more models based on the multidimensional spatial information, the information stored in the one or more models, and the disaster information.

The grid-based data may include risk data in a multidimensional space representing a risk according to the disaster situation for each grid.

The at least one processor may be configured to transmit the created grid-based data to an external system or configured to visualize the created grid-based data according to a risk. Additional aspects of embodiments will be set forth in part in the description which follows and, in part, will be apparent from the description, or may be learned by practice of the disclosure.

According to various embodiments, an object may be modeled according to the type of sensor, information of the object may be registered and managed in a platform, and data may be collected and managed in real time to provide a grid-based service. In addition, the created grid-based data may be used to systematically manage sensing information and disaster information, may help with efficient disaster response, and may be used to develop various intelligent services.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating a platform that manages information related to a disaster situation, according to an embodiment;

FIG. 2 is a diagram illustrating a function and structure of a platform that manages information related to a disaster situation, according to an embodiment;

FIG. 3 is a diagram illustrating various sensors installed in a grid-based space, according to an embodiment;

FIG. 4 is a diagram illustrating a sensor object model to manage various sensors, according to an embodiment;

FIG. 5 is a diagram illustrating a process of registering a sensor in a platform, according to an embodiment;

FIG. 6 is a diagram illustrating a process in which a platform collects sensing information of a sensor, event information, and status information, according to an embodiment;

FIG. 7 is a diagram illustrating a process in which a platform creates and distributes grid-based data, according to an embodiment;

FIG. 8 is a schematic flowchart illustrating a process in which a platform manages information related to a disaster situation, according to an embodiment; and

FIG. 9 is a schematic block diagram illustrating a system that manages information related to a disaster situation, according to an embodiment.

### DETAILED DESCRIPTION

Various modifications may be made to the present disclosure, and the present disclosure may have various embodiments. Thus, the embodiments will be exemplarily shown in the drawings and described in detail in the present specification. Accordingly, the embodiments are not construed as being limited to the disclosure and should be understood to include all changes, equivalents, and replacements within the technical scope of the disclosure.

Terms, such as first, second, and the like, may be used herein to describe components. These terms are only used to distinguish one component from another component. For example, a first component may be referred to as a second component, or similarly, the second component may be referred to as the first component, without departing from the scope of the present disclosure. The term “and/or” includes any one or any combination of the associated listed terms.

In embodiments of the present application, “at least one of A and B” may mean “at least one of A or B” or “at least one of combinations of one or more of A and B.” In addition, in embodiments of the present application, “one or more of A and B” may mean “one or more of A or B” or “one or more of combinations of one or more of A and B.”.

It should be noted that if it is described that one component is “connected”, “coupled”, or “joined” to another component, a third component may be “connected”, “coupled”, and “joined” between the first and second components, although the first component may be directly connected, coupled, or joined to the second component. On the contrary, it should be noted that if it is described that one component is “directly connected”, “directly coupled”, or “directly joined” to another component, a third component may be absent.

The terminology used herein is for the purpose of describing particular embodiments only and is not to be limiting of the embodiments. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which the embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Meanwhile, even if the technology is an art publicly known before the filing date of the present application, it may be included as part of the configuration of the disclosure of the present application when necessary, and this will be described herein within the scope without obscuring the purpose of the present disclosure. However, in describing the configuration of the disclosure of the present application, a detailed description of matters that can be clearly understood by a person skilled in the art as known technology before the date of filing this application may obscure the purpose of the present disclosure, so excessively detailed description of the known technology will be omitted here.

However, the purpose of the present disclosure is not to claim rights to these known technologies, and the content of the known technologies may be included as part of the present disclosure within the scope without departing from the purpose of the present disclosure.

Hereinafter, preferred embodiments of the present disclosure will be described in detail with reference to the accompanying drawings. For easy understanding of the present disclosure, the same reference numerals are used for the same components in the drawings and a repeated description related to the same components will be omitted.

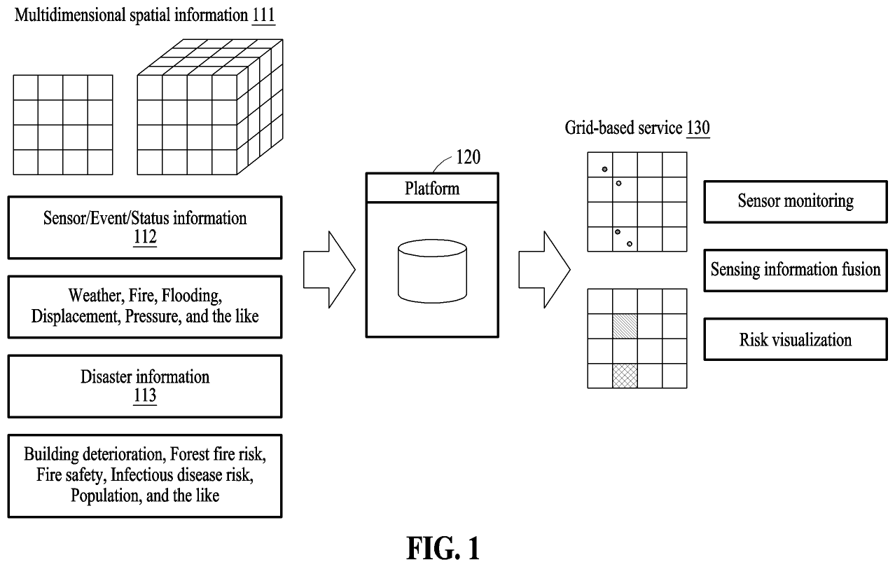

FIG. 1 is a diagram illustrating a platform that manages information related to a disaster situation, according to an embodiment.

FIG. 1 shows a process in which a platform 120 provided with grid-based multidimensional spatial information 111, sensor information 112 of a sensor, and disaster information 113 about a disaster situation creates grid-based data and provides a grid-based service 130.

The grid-based multidimensional spatial information 111 may be grid-based spatial information in which spatial information is divided into a grid unit, and a non-overlapping identification (ID) is assigned to each grid. As shown in FIG. 1, the grid-based multidimensional spatial information 111 may be two-dimensional (2D) spatial information or three-dimensional (3D) spatial information but is not limited thereto. The grid-based multidimensional spatial information 111 based on two dimensions may be according to a national branch number system in which national and marine maps are uniformly divided into a grid and numbered on a plane. In addition, the grid-based multidimensional spatial information 111 based on three dimensions is spatial information in which underground, ground, and air spaces are uniformly divided into a grid and may be spatial information standardized by an international standardization organization, such as the Open Geospatial Consortium or the International Organization for Standardization (ISO). However, embodiments are not limited to the certain grid system described above and may use multidimensional spatial information in any system in which an independent ID is assigned to each grid.

The sensor information 112 may include sensing information sensed by a sensor registered in the platform 120, event information related to a disaster determined based on the sensing information, and status information of the sensor. The sensing information may be information to determine an event related to a disaster, such as the weather, fire, flooding, displacement, pressure, and the like, sensed by the sensor. The event information may be information representing a disaster situation in which the sensing information described above is to be determined according to a certain reference. The status information is information related to a current status of the sensor and may include ID information assigned to the sensor, grid space ID information for a current location of the sensor, and coordinate information of the sensor. The sensor information 112 may be transmitted from the sensor in real time, periodically, or aperiodically. The sensor information 112 transmitted to the platform 120 may be stored in one or more models to manage the sensor in the platform 120 or to distribute information.

The disaster information 113 may be related to the grid-based multidimensional spatial information 111 and may refer to information that may represent the risk or severity of a disaster in relation to a disaster situation. For example, the disaster information 113 may include information, such as building deterioration, forest fire risk, fire safety, infectious disease risk, or population, depending on a disaster situation to respond to.

Based on the grid-based multidimensional spatial information 111, the sensor information 112 stored in the one or more models, and the disaster information 113 described above, the platform 120 to manage a disaster situation may create and output grid-based data to monitor a disaster situation associated with information stored in the one or more models and/or the grid-based multidimensional spatial information 111. The operations and functions of the platform 120 are described in detail below with reference to the accompanying drawings.

The grid-based service 130 provided through the platform 120 may be a service provided using the created grid-based data. That is, services, such as monitoring and managing the sensor using the grid-based data, fusing pieces of sensing information to derive a meaningful value related to a disaster, and calculating the risk to visualize the risk on grid-based spatial information, may be provided. In addition, the grid-based data may be distributed to an external service system and may be used to provide various intelligent services.

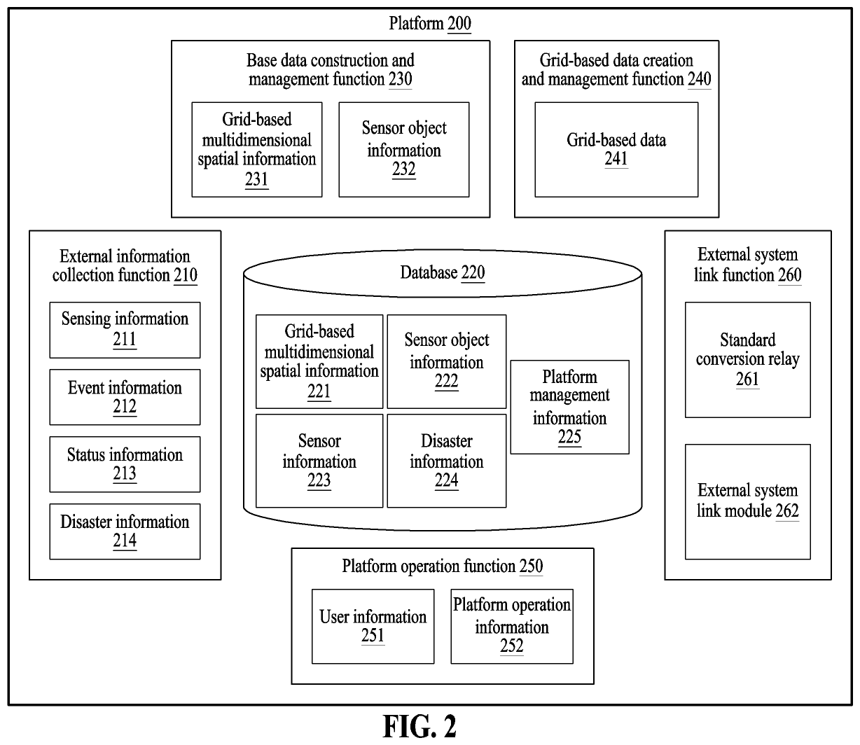

FIG. 2 is a diagram illustrating a function and structure of a platform that manages information related to a disaster situation, according to an embodiment.

FIG. 2 shows, as a function and structure of a platform 200 that manages information related to a disaster situation, an external information collection function 210, a database 220 that stores various pieces of information, and a base data construction and management function 230, a grid-based data creation and management function 240, a platform operation function 250, and an external system link function 260.

The external information collection function 210 may collect various pieces of information from the outside of the platform 200 to manage a disaster situation. For example, external information may include sensing information 211 received from a sensor registered in the platform 200, event information 212, status information 213, and disaster information 214 that may represent the risk or severity of a disaster in relation to a disaster situation. However, the external information is not limited thereto and may include various pieces of information required by the platform 200 to manage a disaster situation.

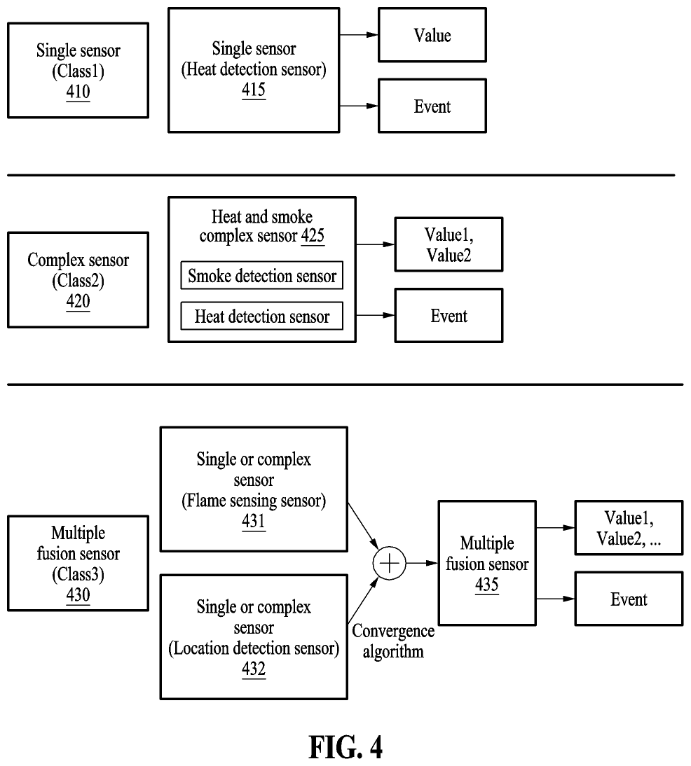

The database 220 in the platform 200 may store information collected to manage a disaster situation and information calculated or processed in the platform 200. For example, the database 220 may store and manage grid-based multidimensional spatial information 221, sensor object information 222, sensor information 223, disaster information 224, and platform management information 225. The grid-based multidimensional spatial information 221 may be grid-based spatial information in which spatial information is divided into a grid unit, and a non-overlapping ID is assigned to each grid. The grid-based multidimensional spatial information 221 may be 2D spatial information or 3D spatial information but is not limited thereto. In addition, the grid-based multidimensional spatial information 221 may include information about a building or facility existing in a corresponding area, in addition to information about the geography and topography of a certain area. The sensor object information 222 is information stored in relation to a sensor object and may include object information of a single sensor, a complex sensor, or a multiple fusion sensor. The sensor registered in the platform 200 is a sensor object model, and the sensor object information 222 may be stored and managed in the database 220. The sensor object information 222 and the sensor object model are described in detail below with reference to FIG. 4. The sensor information 223 may include the sensing information 211 sensed by the sensor registered in the platform 200, the event information 212, and the status information 213 of the sensor and may be stored and managed in the database 220. The disaster information 224 may include the disaster information 214 collected from the outside of the platform 200 and may further include information related to the disaster that is previously stored in the platform 200. The platform management information 225 may represent information for managing the platform 200 such as user information, operation information, and external link system information of the platform 200.

The base data construction and management function 230 may be a function to construct and manage data that is the basis of the platform 200. The data that is the basis of the platform 200 may be grid-based multidimensional spatial information 231 and sensor object information 232. That is, the base data construction and management function 230 may divide spatial information into a grid unit, assign a non-overlapping ID to each grid, create the grid-based multidimensional spatial information 231 using information such as geography, topography, and facilities, and generate the sensor object model for the registration of the sensor.

The grid-based data creation and management function 240 may create grid-based data 241 to monitor a disaster situation using the grid-based multidimensional spatial information 221, the sensor object information 222, the sensor information 223 including the sensing information 211 of the registered sensor, the event information 212, and the status information 213, and the disaster information 224 in the database 220. The grid-based data creation and management function 240 may additionally use a sensor object model, a sensor management model, a sensor data model, and a sensor data distribution model or may use information stored in each model to create the grid-based data 241. The platform 200 may provide a function to allow an administrator or user to manage the created grid-based data 241. For example, the grid-based data creation and management function 230 may provide functions such as registration and deregistration of a sensor object in the grid-based data 241, inquiry of the sensor information 223 of the sensor object, real time information analysis, and information visualization.

The platform operation function 250 may perform a function of managing information for the operation of the platform 200. For example, the platform operation function 250 may operate the platform 200 using user information 251 about a user who uses the platform 200 and platform operation information 252 about a platform operation system and management method.

The external system link function 260 may link the grid-based data 241 created in the platform 200 with an external system and may output the grid-based data 241 externally. The platform 200 may convert the grid-based data 241 into a standard distribution model determined by the platform 200 or a format required by an external system and may output the grid-based data 241 externally. To perform the external system link function 260, the platform 200 may perform a standard conversion relay 261 or may further include an external system link module 262.

The external information collection function 210, the base data construction and management function 230, the grid-based data creation and management function 240, the platform operation function 250, and the external system link function 260 described above are functions that may be performed by an embodiment and are not limited thereto.

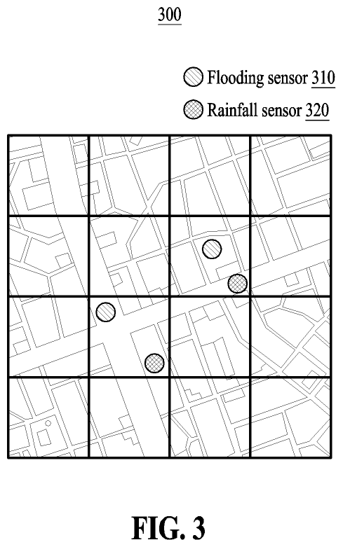

FIG. 3 is a diagram illustrating various sensors installed in a grid-based space, according to an embodiment.

FIG. 3 shows a flooding sensor 310 and a rainfall sensor 320 disposed in a space and registered in a platform and sensors registered in grid-based data 300 to monitor a disaster situation due to rainfall.

In an embodiment, in the case of a disaster situation due to rainfall, one or more flooding sensors or one or more rainfall sensors may be disposed at certain locations in a space by considering disaster information, etc. The certain locations may be selected by an administrator from the grid-based space and no location may be selected in one grid or more than one location may be selected in one grid. The flooding sensor 310 and the rainfall sensor 320 may detect the degree of flooding and the amount of rainfall, respectively. One or more of pieces of status information including sensing information sensed by each sensor, flooding event information determined based on the sensing information, and location information of a sensor may be transmitted to the platform. In an embodiment, the platform may determine whether an event occurs using the sensing information sensed by each sensor.

In FIG. 3, for example, although the flooding sensor 310 and the rainfall sensor 320 are displayed on the grid-based data 300, embodiments are not limited thereto, and one or more types of sensors to determine whether one or more events occur may be disposed and displayed. In addition, different types of sensors may be used depending on various disaster situations, such as the weather, earthquakes, fires, and infectious diseases, rather than disasters due to rainfall.

FIG. 4 is a diagram illustrating a sensor object model to manage various sensors, according to an embodiment.

Referring to FIG. 4, a single sensor 410, a complex sensor 420, and a multiple fusion sensor 430 may be defined as a sensor object model for registration and management of a sensor in a platform.

The single sensor 410 may be a model that may determine whether one event occurs using a sensor that senses one value. For example, a heat detection sensor 415 may sense heat and may determine whether a fire event occurs based on the sensed temperature value.

The complex sensor 420 may be a model that may determine whether one event occurs using a sensor that senses two or more values. For example, a heat and smoke complex sensor 425 may sense heat and smoke and may determine whether a fire event occurs based on the sensed temperature value and smoke value.

The multiple fusion sensor 430 may be a model that may determine whether one event occurs using one or more single or complex sensors. That is, the multiple fusion sensor 430 may be a model that combines a plurality of physical sensors and groups the plurality of physical sensors into one logical sensor. In an embodiment, operations, such as the four fundamental rules of arithmetic, a logical operation, and a comparison operation, or an algorithm, such as machine learning, may be used to combine the plurality of physical sensors. For example, a multiple fusion sensor 435 may be configured using a flame sensing sensor 431 and a location detection sensor 432 using a certain algorithm, and the type of fire may be determined using values sensed by each sensor.

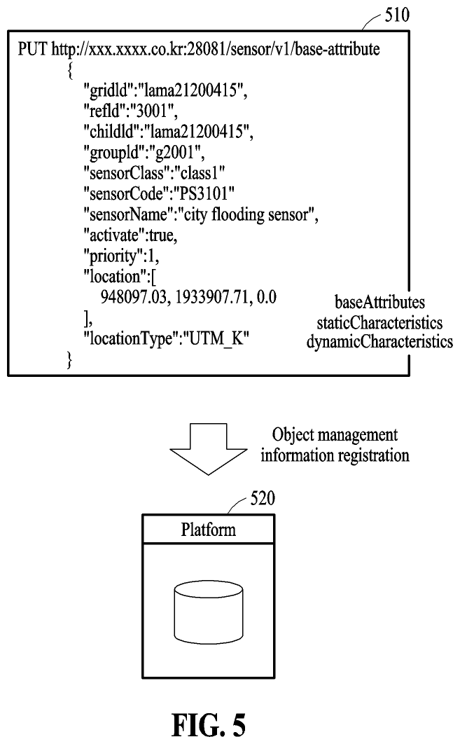

Sensors may be registered as models of the single sensor 410, the complex sensor 420, and the multiple fusion sensor 430 to manage sensors in the platform. However, embodiments are not limited thereto, and the sensors may be registered as various models. A sensor management model, a sensor data model, and a sensor data distribution model to manage and distribute sensors registered as sensor object models are described in detail below with reference to FIGS. 5 to 7.

FIG. 5 is a diagram illustrating a process of registering a sensor in a platform, according to an embodiment.

FIG. 5 shows a process in which a sensor management model 510 including information to manage a sensor is registered in a platform 520.

The sensor management model 510 may include a basic attribute information model (baseAttributes) including information to manage a sensor on grid-based data, a static characteristic information model (staticCharacteristics) including specification information of a sensor provided by a manufacturer, and a dynamic characteristic information model (dynamicCharacteristics) including environment setting information that may be dynamically changed in the sensor operation.

The basic attribute information model (baseAttributes) may include, for example, attribute information shown in Table 1.

TABLE 1

| Attribute Name | Type | Description | Note |
|---|---|---|---|
| gridId | STRING | Grid ID | An identifier of a |
| | | | grid corresponding |
| | | | to a location where a |
| | | | sensor is disposed. |
| refId | STRING | Sensor ID | An identifier |
| | | | assigned to each |
| | | | sensor to distinguish |
| | | | sensors. |
| groupId | STRING | Group ID | An identifier |
| | | | representing a group |
| | | | to which a sensor |
| | | | belongs. |
| sensorName | STRING | Sensor Name | A name of a sensor |
| | | | (e.g., a flooding |
| | | | sensor, a heat sensor, |
| | | | a heat and smoke |
| | | | complex sensor, |
| | | | etc.). |
| sensorCode | STRING | Sensor Code | Code information |
| | | | (e.g., PS3101, |
| | | | FS1101, FS1211, |
| | | | etc.) to distinguish |
| | | | the type of sensor. |
| sensorClass | STRING | Object Model | Model information |
| | | | to distinguish sensor |
| | | | object models (e.g., |
| | | | class1, class2, and |
| | | | class3). |
| childIds | OBJECT | Member ID | A set of sensor IDs |
| | | | of members forming |
| | | | multiple fusion |
| | | | sensors. |
| activate | BOOLEAN | Active Status | Information |
| | | | representing whether |
| | | | a sensor is activated |
| | | | or not. |
| priority | INTEGER | Priority | Priority for |
| | | | processing |
| | | | information |
| | | | reception. |
| location | OBJECT | Location | Coordinate |
| | | Coordinate | information |
| | | | corresponding to a |
| | | | location where a |
| | | | sensor is installed. |
| locationType | STRING | Location | Coordinate system |
| | | Coordinate | information of |
| | | Type | location information |
| | | | (e.g., a relative |
| | | | coordinate, WGS84, |
| | | | BESSEL, TM, |
| | | | UTM_K, etc.). |

The static characteristic information model (staticCharacteristics) may include, for example, characteristic information shown in Table 2.

TABLE 2

| Characteristic Name | Type | Description | Note |
|---|---|---|---|
| gridId | STRING | Grid ID | An identifier of a |
| | | | grid corresponding |
| | | | to a location where a |
| | | | sensor is disposed. |
| refId | STRING | Sensor ID | An identifier |
| | | | assigned to each |
| | | | sensor to distinguish |
| | | | sensors. |
| numOfValues | INTEGER | Number of | The number of |
| | | Sensing | sensing values for |
| | | Values | sensing information |
| | | | transmission. |
| unit | OBJECT | Sensor Unit | A unit of sensing |
| | | | values that may be |
| | | | configured in |
| | | | multiple ways |
| | | | according to the |
| | | | sensing values. |
| maxValue | OBJECT | Sensor | The maximum value |
| | | Maximum | of sensing values |
| | | Value | that may be |
| | | | configured in |
| | | | multiple ways |
| | | | according to the |
| | | | sensing values. |
| minValue | OBJECT | Sensor | The minimum value |
| | | Minimum | of sensing values |
| | | Value | that may be |
| | | | configured in |
| | | | multiple ways |
| | | | according to the |
| | | | sensing values. |
| accuracy | OBJECT | Sensor | Accuracy of a sensor |
| | | Accuracy | that may be |
| | | | configured in |
| | | | multiple ways |
| | | | according to sensing |
| | | | values. |
| sensitivity | OBJECT | Sensor | Sensitivity of a |
| | | Sensitivity | sensor that may be |
| | | | configured in |
| | | | multiple ways |
| | | | according to sensing |
| | | | value. |
| resolution | OBJECT | Sensor | Resolution of a |
| | | Resolution | sensor that may be |
| | | | configured in |
| | | | multiple ways |
| | | | according to sensing |
| | | | value. |

The dynamic characteristic information model (dynamicCharacteristics) may include, for example, characteristic information shown in Table 3.

TABLE 3

| Characteristic Name | Type | Description | Note |
|---|---|---|---|
| gridId | STRING | Grid ID | An identifier of a |
| | | | grid corresponding |
| | | | to a location where a |
| | | | sensor is disposed. |
| refId | STRING | Sensor ID | An identifier |
| | | | assigned to each |
| | | | sensor to distinguish |
| | | | sensors. |
| samplingRate | OBJECT | Data | A sampling rate to |
| | | Acquisition | acquire data of a |
| | | Rate | sensor. |
| txPeriod | INTEGER | Sensing | A period for sensing |
| | | Information | information |
| | | Transmission | transmission. |
| | | Period | |
| aboveThresholdValue | OBJECT | Above | An above threshold |
| | | Threshold | to determine that an |
| | | | event occurs. |
| belowThresholdValue | OBJECT | Below | A below threshold to |
| | | Threshold | determine that an |
| | | | event occurs. |

The sensor management model 510 and the pieces of attribute and characteristic information described above are only examples, and embodiments are not limited thereto.

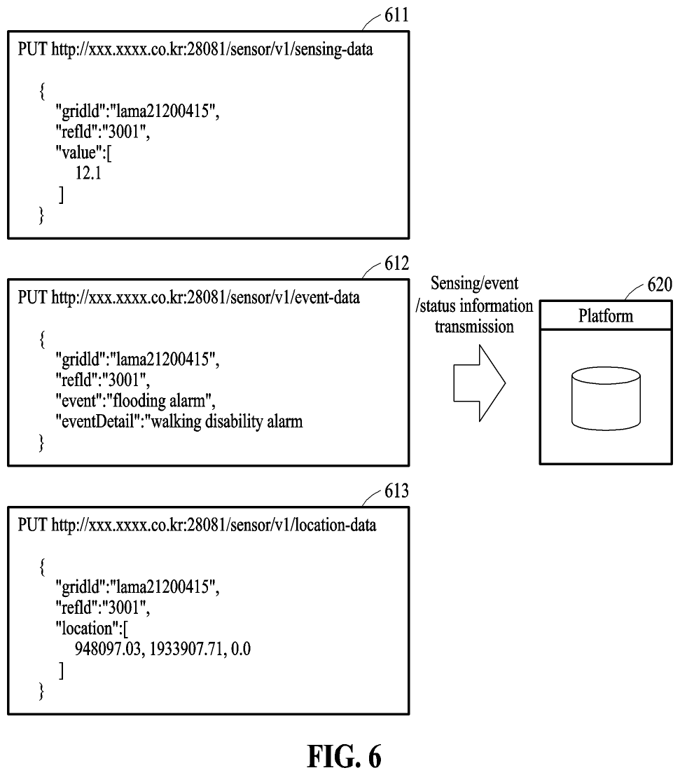

FIG. 6 is a diagram illustrating a process in which a platform collects sensing information of a sensor, event information, and status information, according to an embodiment.

FIG. 6 shows a process in which sensor information including sensing information sensed by a registered sensor, event information, and status information of the sensor is transmitted to a platform 620 as data models 611, 612, and 613 of sensors.

The data models 611, 612, and 613 of the sensors may include the sensing information data model 611 including the sensing information acquired periodically or aperiodically from the registered sensor, the event information data model 612 including an event message transmitted when an event occurrence is detected, and the status information data model 613 including the status information such as a location of a sensor acquired periodically or aperiodically.

The sensing information data model 611 may include, for example, attribute information shown in Table 4.

TABLE 4

| Attribute Name | Type | Description | Note |
|---|---|---|---|
| gridId | STRING | Grid ID | An identifier of a |
| | | | grid corresponding |
| | | | to a location where a |
| | | | sensor is disposed. |
| refId | STRING | Sensor ID | An identifier |
| | | | assigned to each |
| | | | sensor to distinguish |
| | | | sensors. |
| value | OBJECT | Sensing Value | A sensing value |
| | | | sensed by a sensor. |

The event information data model 612 may include, for example, attribute information shown in Table 5.

TABLE 5

| Attribute Name | Type | Description | Note |
|---|---|---|---|
| gridId | STRING | Grid ID | An identifier of a |
| | | | grid corresponding |
| | | | to a location where a |
| | | | sensor is disposed. |
| refId | STRING | Sensor ID | An identifier |
| | | | assigned to each |
| | | | sensor to distinguish |
| | | | sensors. |
| event | STRING | Event Value | The type of message |
| | | | and event for an |
| | | | event sensed by a |
| | | | sensor. |
| eventDetail | STRING | Event Detailed | A detailed message |
| | | Value | about an event |
| | | | sensed by a sensor. |

The status information data model 613 may include, for example, attribute information shown in Table 6.

TABLE 6

| Attribute Name | Type | Description | Note |
|---|---|---|---|
| gridId | STRING | Grid ID | An identifier of a |
| | | | grid corresponding |
| | | | to a location where a |
| | | | sensor is disposed. |
| refId | STRING | Sensor ID | An identifier |
| | | | assigned to each |
| | | | sensor to distinguish |
| | | | sensors. |
| location | OBJECT | Location | Coordinate |
| | | Coordinates | information |
| | | | corresponding to a |
| | | | current location of a |
| | | | sensor. |

The data models 611, 612, and 613 of the sensors and the pieces of attribute information described above are only examples, and embodiments are not limited thereto.

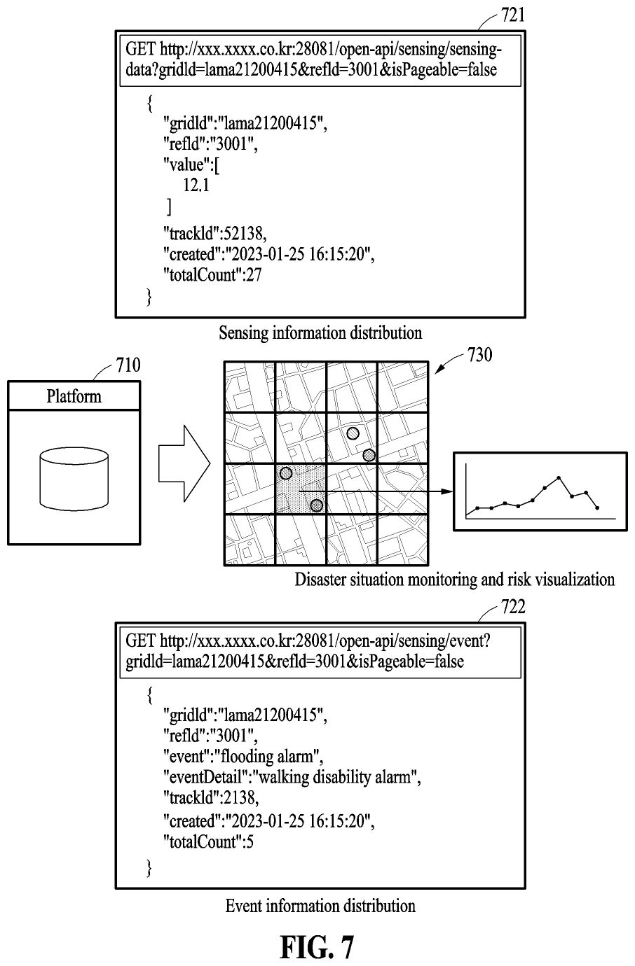

FIG. 7 is a diagram illustrating a process in which a platform creates and distributes grid-based data, according to an embodiment.

FIG. 7 shows a process in which a platform 710 distributes information externally using a sensor data distribution model. The sensor data distribution model may be a model to externally distribute the created grid-based data or information stored in a sensor object model or a sensor data model. The sensor data distribution model may include a sensing data distribution model 721 to distribute sensing information sensed by a sensor, an event data distribution model 722 to distribute event information sensed by the sensor, and a status data distribution model to distribute status information of the sensor.

The sensing data distribution model 721 may include, for example, attribute information shown in Table 7.

TABLE 7

| Attribute Name | Type | Description | Note |
|---|---|---|---|
| gridId | STRING | Grid ID | An identifier of a |
| | | | grid corresponding |
| | | | to a location where a |
| | | | sensor is disposed. |
| refId | STRING | Sensor ID | An identifier |
| | | | assigned to each |
| | | | sensor to distinguish |
| | | | sensors. |
| value | OBJECT | Sensing Value | A sensing value |
| | | | sensed by a sensor. |
| trackId | integer | Data ID | An identifier of |
| | | | sensing data. |
| created | timestamp | Creation Date and | The time when |
| | | Time | sensing data is |
| | | | created. |
| totalCount | long | Total Count of Data | The total count of |
| | | | pieces of viewed |
| | | | sensing data. |

The event data distribution model 722 may include, for example, attribute information shown in Table 8.

TABLE 8

| Attribute Name | Type | Description | Note |
|---|---|---|---|
| gridId | STRING | Grid ID | An identifier of a |
| | | | grid corresponding |
| | | | to a location where a |
| | | | sensor is disposed. |
| refId | STRING | Sensor ID | An identifier |
| | | | assigned to each |
| | | | sensor to distinguish |
| | | | sensors. |
| event | STRING | Event Value | The type of message |
| | | | and event for an |
| | | | event sensed by a |
| | | | sensor. |
| eventDetail | STRING | Event Detailed | A detailed message |
| | | Value | about an event |
| | | | sensed by a sensor. |
| trackId | integer | Data ID | An identifier of |
| | | | event data. |
| created | timestamp | Creation Date and | The time when event |
| | | Time | data is created. |
| totalCount | long | Total Count of | The total count of |
| | | Data | pieces of viewed |
| | | | event data. |

The status data distribution model may include, for example, attribute information shown in Table 9.

TABLE 9

| Attribute Name | Type | Description | Note |
|---|---|---|---|
| gridId | STRING | Grid ID | An identifier of a |
| | | | grid corresponding |
| | | | to a location where a |
| | | | sensor is disposed. |
| refId | STRING | Sensor ID | An identifier |
| | | | assigned to each |
| | | | sensor to distinguish |
| | | | sensors. |
| location | OBJECT | Location | Coordinate |
| | | Coordinates | information |
| | | | corresponding to a |
| | | | current location of a |
| | | | sensor. |
| trackId | integer | Data ID | An identifier of |
| | | | status data. |
| created | timestamp | Creation Date and | The time when status |
| | | Time | data is created. |
| totalCount | long | Total Count of | The total count of |
| | | Data | pieces of viewed |
| | | | status data. |

The sensor data distribution model and the pieces of attribute information described above are only examples, and embodiments are not limited thereto.

In an embodiment, after the platform 710 distributes information externally using the sensor data distribution model, the distributed information may be used to monitor a disaster situation or in combination with various external systems. For example, the risk may be calculated using distributed grid-based data 730, and the calculated risk may be visualized on the distributed grid-based data 730. Additionally, the platform 710 may be used to develop various intelligent services that may analyze a disaster situation by combining with an intelligent artificial intelligence (AI) model.

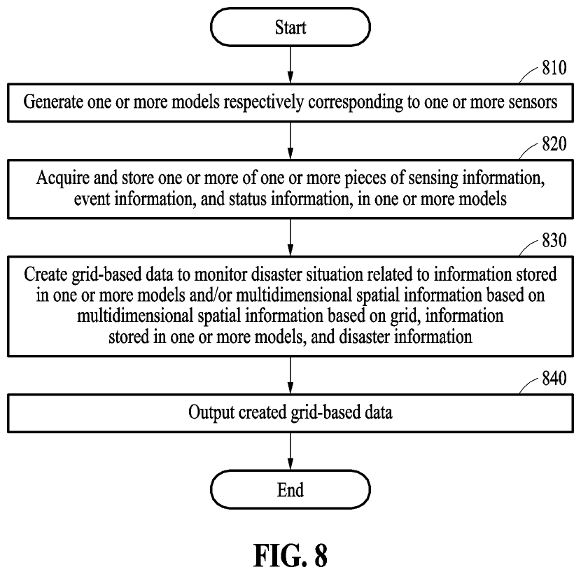

FIG. 8 is a schematic flowchart illustrating a process in which a platform manages information related to a disaster situation, according to an embodiment.

FIG. 8 shows a process of generating models for one or more sensors and creating and outputting grid-based data to monitor a disaster situation using the generated models and multidimensional spatial information.

In operation 810, a system may generate one or more models respectively corresponding to the one or more sensors.

In operation 820, the system may acquire and store one or more of one or more pieces of sensing information sensed by the one or more sensors, event information determined based on the one or more pieces of sensing information, and status information of the one or more sensors, in the one or more models.

In operation 830, the system may create the grid-based data to monitor a disaster situation related to information stored in the one or more models and/or the multidimensional spatial information based on multidimensional spatial information based on a grid on which the one or more sensors are disposed, the information stored in the one or more models, and disaster information related to the multidimensional spatial information.

In operation 840, the system may output the created grid-based data. The system may transmit the created grid-based data to an external system or may visualize the created grid-based data according to the risk.

The one or more models may include at least one of a sensor object model representing a model corresponding to the one or more sensors, a sensor management model including information to manage the one or more sensors, a sensor data model including information received from the one or more sensors, or a sensor data distribution model to query the information received from the one or more sensors. The sensor object model may include a model for a sensor that determines whether an event occurs using one or more pieces of sensing information sensed by the one or more sensors. The sensor management model may include information about the one or more sensors and/or information about a dynamic environmental setting of the one or more sensors. The sensor data model may include at least one of the one or more pieces of sensing information sensed by the one or more sensors, the event information, or location information of the one or more sensors. The grid-based data may control the one or more sensors and/or the one or more models based on the multidimensional spatial information, the information stored in the one or more models, and the disaster information. The grid-based data may include risk data in a multidimensional space representing the risk according to a disaster situation for each grid.

The descriptions provided with reference to FIGS. 1 to 7 may apply to the operations shown in FIG. 8, and thus, further detailed descriptions are omitted.

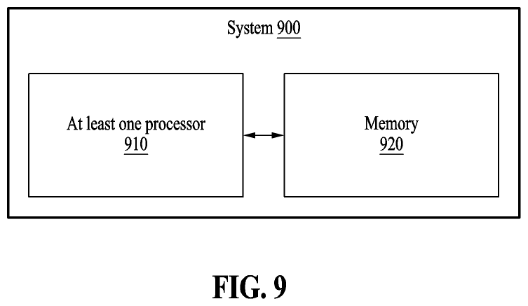

FIG. 9 is a schematic block diagram illustrating a system that manages information related to a disaster situation, according to an embodiment.

Referring to FIG. 9, a system 900 may include at least one processor 910 and may further include a memory 920.

The memory 920 may store instructions (e.g., programs) executable by the at least one processor 910. For example, the instructions may include instructions for executing the operation of the at least one processor 910 and/or the operation of each component of the at least one processor 910.

The at least one processor 910 may be a device that executes instructions or programs or controls the system 900 and may include, for example, various processors such as a central processing unit (CPU) and a graphics processing unit (GPU). The at least one processor 910 may generate one or more models respectively corresponding to one or more sensors. The at least one processor 910 may acquire and store one or more of one or more pieces of sensing information sensed by the one or more sensors, event information determined based on the one or more pieces of sensing information, and status information of the one or more sensors, in the one or more models. The at least one processor 910 may create grid-based data to monitor a disaster situation related to information stored in the one or more models and/or multidimensional spatial information based on multidimensional spatial information based on a grid on which the one or more sensors are disposed, information stored in the one or more models, and disaster information related to the multidimensional spatial information. The at least one processor 910 may output the created grid-based data.

The at least one processor 910 may transmit the created grid-based data to an external system or may visualize the created grid-based data according to the risk. The one or more models may include at least one of a sensor object model representing a model corresponding to the one or more sensors, a sensor management model including information to manage the one or more sensors, a sensor data model including information received from the one or more sensors, or a sensor data distribution model to query the information received from the one or more sensors. The sensor object model may include a model for a sensor that determines whether an event occurs using one or more pieces of sensing information sensed by the one or more sensors. The sensor management model may include information about the one or more sensors and/or information about a dynamic environmental setting of the one or more sensors. The sensor data model may include at least one of the one or more pieces of sensing information sensed by the one or more sensors, the event information, or location information of the one or more sensors. The grid-based data may control the one or more sensors and/or the one or more models based on the multidimensional spatial information, the information stored in the one or more models, and the disaster information. The grid-based data may include risk data in a multidimensional space representing the risk according to a disaster situation for each grid.

According to an embodiment, the system 900 may also be implemented as an electronic device. For example, the electronic device may include, but is not limited thereto, various computing devices, such as a mobile phone, a smartphone, a tablet personal computer (PC), an electronic book (e-book) device, a laptop computer, a PC, a desktop, a workstation, or a server, various wearable devices, such as a smart watch, smart eyeglasses, a head-mounted display (HMD), or smart clothing, various home appliances, such as a smart speaker, a smart television (TV), or a smart refrigerator, and other devices, such as a smart car, a smart kiosk, an Internet of Things (IoT) device, a walking assist device (WAD), a drone, or a robot.

In addition, the system 900 may process the operations described above.

The components described in the embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the embodiments may be implemented by software, and the software may be recorded on a recording medium. The components, the functions, and the processes described in the embodiments may be implemented by a combination of hardware and software.

The embodiments described herein may be implemented using a hardware component, a software component, and/or a combination thereof. A processing device may be implemented using one or more general-purpose or special-purpose computers, such as, for example, a processor, a controller and an arithmetic logic unit (ALU), a DSP, a microcomputer, an FPGA, a programmable logic unit (PLU), a microprocessor or any other device capable of responding to and executing instructions in a defined manner. The processing device may run an OS and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and/or multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be stored in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs and/or DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher-level code that may be executed by the computer using an interpreter.

The above-described hardware devices may be configured to act as one or more software modules in order to perform the operations of the above-described embodiments, or vice versa.

As described above, although the embodiments have been described with reference to the limited drawings, a person skilled in the art may apply various technical modifications and variations based thereon. For example, suitable results may be achieved if the described techniques are performed in a different order, and/or if components in a described system, architecture, device, or circuit are combined in a different manner, or replaced or supplemented by other components or their equivalents.

Accordingly, other implementations are within the scope of the following claims.

What is claimed is:

1. An operating method of a system, the operating method comprising:
generating one or more models respectively corresponding to one or more sensors;
acquiring and storing one or more of one or more pieces of sensing information sensed by the one or more sensors, event information determined based on the one or more pieces of sensing information, and status information of the one or more sensors, in the one or more models;
based on multidimensional spatial information based on a grid on which the one or more sensors are disposed, information stored in the one or more models, and disaster information related to the multidimensional spatial information, creating grid-based data to monitor a disaster situation associated with the information stored in the one or more models and/or the multidimensional spatial information; and
outputting the created grid-based data.

2. The operating method of claim 1, wherein the one or more models comprise a sensor object model representing a model corresponding to the one or more sensors, a sensor management model comprising information to manage the one or more sensors, a sensor data model comprising information received from the one or more sensors, and a sensor data distribution model to query the information received from the one or more sensors.

3. The operating method of claim 2, wherein the sensor object model comprises a model for a sensor configured to determine whether an event occurs using the one or more pieces of sensing information sensed by the one or more sensors.

4. The operating method of claim 2, wherein the sensor management model comprises information about the one or more sensors and/or information about a dynamic environment setting of the one or more sensors.

5. The operating method of claim 2, wherein the sensor data model comprises at least one of the one or more pieces of sensing information sensed by the one or more sensors, the event information, or location information of the one or more sensors.

6. The operating method of claim 1, wherein the grid-based data controls the one or more sensors and/or the one or more models based on the multidimensional spatial information, the information stored in the one or more models, and the disaster information.

7. The operating method of claim 1, wherein the grid-based data comprises risk data in a multidimensional space representing a risk according to the disaster situation for each grid.

8. The operating method of claim 1, wherein the outputting of the created grid-based data comprises:
transmitting the created grid-based data to an external system; or
visualizing the created grid-based data according to a risk.

9. A system comprising:
at least one processor configured to generate one or more models respectively corresponding to one or more sensors, acquire and store one or more of one or more pieces of sensing information sensed by the one or more sensors, event information determined based on the one or more pieces of sensing information, and status information of the one or more sensors, in the one or more models, based on multidimensional spatial information based on a grid on which the one or more sensors are disposed, information stored in the one or more models, and disaster information related to the multidimensional spatial information, create grid-based data to monitor a disaster situation associated with the information stored in the one or more models and/or the multidimensional spatial information, and output the created grid-based data.

10. The system of claim 9, wherein the one or more models comprise at least one of a sensor object model representing a model corresponding to the one or more sensors, a sensor management model comprising information to manage the one or more sensors, a sensor data model comprising information received from the one or more sensors, or a sensor data distribution model to query the information received from the one or more sensors.

11. The system of claim 10, wherein the sensor object model comprises a model for a sensor configured to determine whether an event occurs using the one or more pieces of sensing information sensed by the one or more sensors.

12. The system of claim 10, wherein the sensor management model comprises information about the one or more sensors and/or information about a dynamic environment setting of the one or more sensors.

13. The system of claim 10, wherein the sensor data model comprises at least one of the one or more pieces of sensing information sensed by the one or more sensors, the event information, or location information of the one or more sensors.

14. The system of claim 9, wherein the grid-based data controls the one or more sensors and/or the one or more models based on the multidimensional spatial information, the information stored in the one or more models, and the disaster information.

15. The system of claim 9, wherein the grid-based data comprises risk data in a multidimensional space representing a risk according to the disaster situation for each grid.

16. The system of claim 9, wherein the at least one processor is configured to transmit the created grid-based data to an external system or configured to visualize the created grid-based data according to a risk.
